(19) United States
(12) Patent Application Publication
(10) Pub. No.: US 2020/0163823 A1
(43) Pub. Date: May 28, 2020

(54) Constipation treatment apparatus using warm and air cells

(71) Applicant: BMS CO., LTD, Paju-si (KR)

(72) Inventors: Tae Young Kim, Cheongju-si (KR); Sin Il Moon, Goyang-si (KR)

(21) Appl. No.: 16/200,746

(22) Filed: Nov. 27, 2018

(51) Int. Cl. A61H 9/00

(52) U.S. Cl. CPC A61H 9/0078; A61H 2201/165; A61H 2201/1238; A61H 2201/0207

(57) ABSTRACT

Disclosed is a constipation treatment apparatus using warm and air cells. A constipation apparatus may provide stomach message by a complementary therapy for reducing chronic constipation together with heat and preventing foods inside a stomach (stomach twist) due to excessive pressure from back-flowing by using an air cell.

### BACKGROUND OF THE INVENTION

### Field of the Invention

The present invention relates to a constipation apparatus using warm and air cells, and more particularly to a constipation apparatus using warm and air cells for providing a circulation control structure matching with bowel movement and a structure suited to a skeleton structure of a body.

### Description of the Related Art

Constipation is generally digestive symptom to appeal. 20% is increased in the western and the constipation is gradually increased in Korea so that prevalence of 16.5% is reported and the constipation is further increased in women, children, and old men.

Constipation surprisingly causes a serious influence on the everyday life to apply misery beyond a degree of discomforting the everyday life and to cause a serious result such as wrong abuse and side effect of medicine.

The constipation is generated from endocrine disease, metabolic disease, neurological disease or organic disease such as colorectal cancer but mostly appears as a functional constipation without knowing a reason so that it is difficult to cure the constipation. Further, symptoms related to the constipation are intermittent and weak in most cases but are difficult to chronically and continuously cure the above symptoms.

The constipation is a very common chronic disease where improvement and aggravation of a symptom are repeated to deteriorate the quality of the life and to reduce medical treatment and physical metal function so that socioeconomic loss is caused. Accordingly, the suitable development of cure guideline of constipation is to develop a device capable of easily giving efficient help to constipation cure in everyday life because it is determined that socioeconomic benefit is high due to an efficient use of a current limited medical treatment resource and improvement of patients.

Today, a treatment device provided as a stomach message device for constipation cure mainly includes only a message device by a mechanical device. A message device using warm and air cells is rarely used.

The message device using warm and air cells may perform a message function by fully injecting and exhausting air instead of separately operating an air cell.

Accordingly, since a bowel performs peristalsis in a case of stomach, if a message is wrong performed, foods and the like rather backflow so that the message device using warm and air cells is not suitable for a stomach message device.

Therefore, a corresponding technical field uses warm and air cells. There is a need to develop a technology for solving a problem which cannot adjust pressed pressure to perform message by an existing mechanic device and not to backflow foods associated with peristalsis of a bowel.

### SUMMARY OF THE INVENTION

The present invention has been made in view of the above problems, and provides a constipation apparatus using warm and air cells for providing stomach message by a complementary therapy for reducing chronic constipation together with heat and preventing foods inside a stomach (stomach twist) due to excessive pressure from back-flowing by using an air cell.

The present invention further provides a constipation apparatus using warm and air cells for improving constipation symptom by reinforcing stomach muscle, exalting peristalsis of stomach, reducing pass time of stomach, and increasing regularity of a bowel and bowel movement.

The present invention further provides a constipation apparatus using warm and air cells being non-invasive for preventing side effect harmful in a body using a stomach message device and performing by a patient by a simple method.

The above information disclosed in this background section is only for enhancement of understanding of the background of the invention and therefore it may contain information that does not form the prior art that is already known in this country to a person of ordinary skill in the art.

In accordance with an aspect of the present disclosure, a constipation treatment apparatus using warm and air cells, the apparatus including: a vacuum motor 140 installed at an internal space of a curved frame 110 to supply air generated from a supply pipe 1 to the air cell; a heat/message module group 150a to 150e including a lower right heat/message module 150a, a right heat/message module 150b, a central heat/message module 150c, a lower left warm/message module 105d, and a left heat/message module 150e, each of heat/message modules 150a to 150e including an air cell and a heat generation module 150-3; and a control unit 180 configured to control the heat generation module 150-3 and the air cell every divided part where the heat/message modules 150a to 150e are divided into a plurality of parts.

The constipation treatment apparatus using warm and air cells may further include a solenoid valve group 170a to 170e configured by a solenoid valve 170 installed at a supply pipe 1 at an internal space of the curved frame 110 of the constipation treatment apparatus using warm and air cells.

The solenoid valve group 170a to 170e may perform air injection and exhaustion with respect to the air cell of at least one heat/message module of the heat/message module group 150a to 150e.

The solenoid valve group 170a to 170e may include a lower solenoid valve 170a, a right solenoid valve 170b, a central solenoid valve 170c, a lower left solenoid valve 170d, and a left solenoid valve 170e.

The air cells 150-1 and 150-2 may be overlapped with an upper portion of the heat generation module 150-3 making contact with a body.

The heat generation module 150-3 internally makes contact with a body skin.

The air cell may be configured by a dual structure including an upper air cell 150-1 and a lower air cell 150-2.

A diameter of an air supply port of the lower air cell 150-2 may be greater than a diameter of an air supply port of the upper air cell 150-1, the supply pipe 1 is connected to the lower air cell 150-2,

The upper air cell 150-1 and the lower air cell 150-2 may include thermo-plastic polyurethane (TPU).

In the present invention, divided parts (five pieces) of the upper air cell 150-1 and the lower air cell 150-2 and the heat generation module 150-3 include one upper piece corresponding to the central heat/message module 150c, lower two pieces corresponding to the lower right heat/message module 150a and a lower left heat/message module 150d, a left piece corresponding to a left heat/message module 150, and a right piece corresponding to a right heat/message module 150d.

Further, in the present invention, a valve for injecting air into a lower air cell 150-2 of the heat/message module group 150a to 150e uses a solenoid valve, and the control unit 180 controls the solenoid valve 170 and the vacuum motor 140 so that air is sequentially injected into respective air cells 150-1 and 150-2 from the vacuum motor 140.

A constipation apparatus using warm and air cells according to an embodiment of the present invention may provide stomach message by a complementary therapy for reducing chronic constipation together with heat and preventing foods inside a stomach (stomach twist) due to excessive pressure from back-flowing by using an air cell.

A constipation apparatus using warm and air cells according to another embodiment of the present invention may improve constipation symptom by reinforcing stomach muscle, exalting peristalsis of stomach, reducing pass time of stomach, and increasing regularity of a bowel and bowel movement.

A constipation apparatus using warm and air cells according to another embodiment of the present invention may further provide a constipation apparatus using warm and air cells being non-invasive for preventing side effect harmful in a body using a stomach message device and performing by a patient by a simple method.

### BRIEF DESCRIPTION OF THE DRAWINGS

The objects, features and advantages of the present disclosure will be more apparent from the following detailed description in conjunction with the accompanying drawings, in which:

FIG. 1 is a perspective view illustrating a constipation apparatus 100 using warm and air cells according to an embodiment of the present invention;

FIG. 2a is a left side view illustrating a constipation apparatus 100 using warm and air cells and

FIG. 2b is a view illustrating an input device 130 according to an embodiment of the present invention;

FIG. 3a is a front view and FIG. 3b is a left side view illustrating a constipation apparatus 100 using warm and air cells according to an embodiment of the present invention;

FIG. 4 is a view a constipation apparatus 100 using warm and air cells according to an embodiment of the present invention;

FIG. 5 is a diagram illustrating a message scheme according to arrangement of heat/message module group 150a to 150e in a constipation apparatus 100 using warm and air cells according to an embodiment of the present invention;

FIGS. 6a and 6b are diagrams illustrating structures of an upper air cell 150-1 and a lower air cell 150-2 configuring each heat/message module of heat/message module group 150a to 150e in a constipation apparatus 100 using warm and air cells according to an embodiment of the present invention;

FIG. 7 is a sectional view taken along line A-A′ of FIG. 6a; and

FIG. 8 is a block diagram illustrating respective constituent elements of a constipation apparatus 100 using warm and air cells according to an embodiment of the present invention.

### DETAILED DESCRIPTION OF EXEMPLARY EMBODIMENTS

The details of other embodiments are contained in the detailed description and accompanying drawings. In the following description, if detailed description about well-known functions or configurations may make the subject matter of the disclosure unclear, the detailed description.

In the specification, a case where one constituent element transmits data or a signal to another constituent element means a case where a constituent element may directly transmit the data or the signal to another constituent element and may transmit the data or the signal through at least one other constituent element.

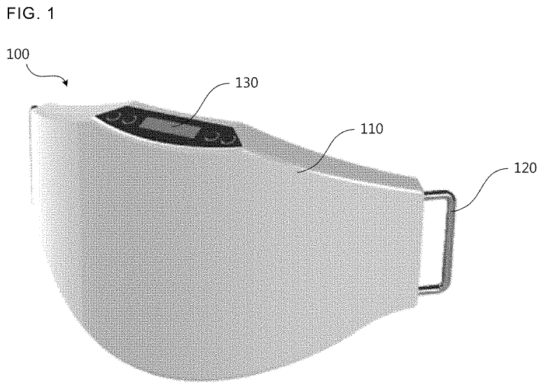

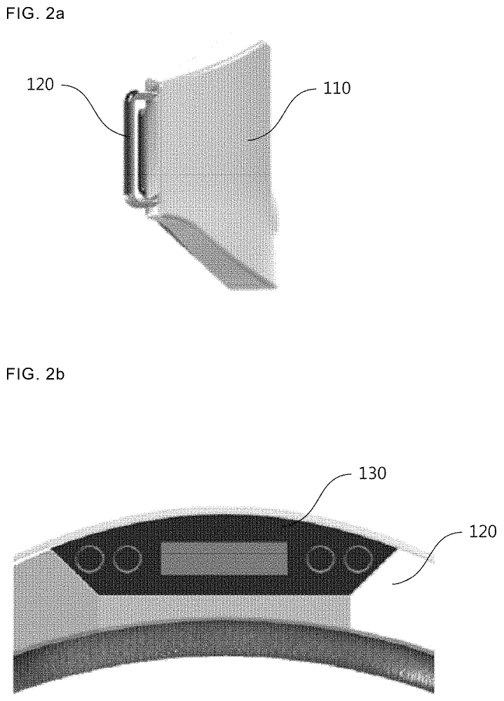

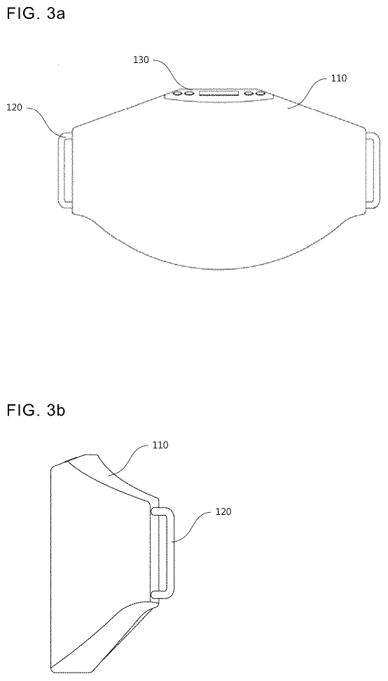

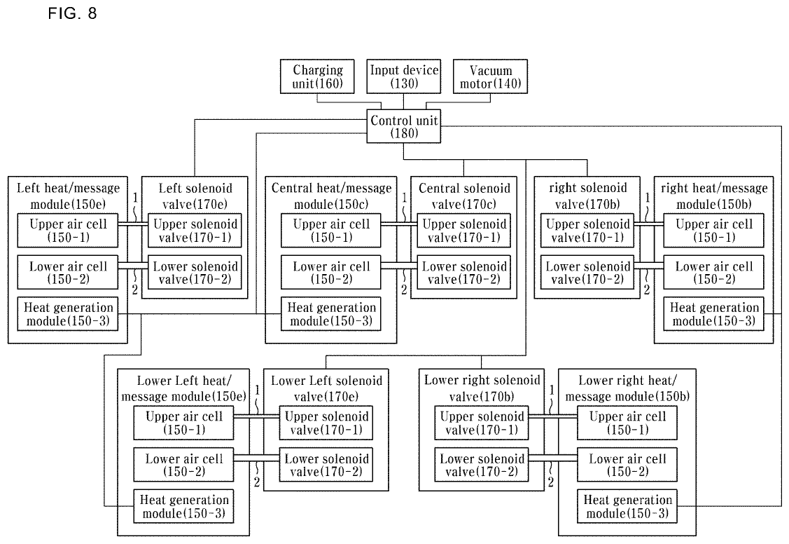

Referring to FIG. 1 to FIG. 8, the constipation apparatus 100 using warm and air cells according to an embodiment of the present invention may include a curved frame 110, a belt attachment stage 120, an input device 130, a vacuum motor 140, a heat/message module group 150a to 150e, a charging unit 160 configured by a charging battery, a solenoid valve group 170a to 170e, and a control unit 180.

The vacuum motor 140 is installed an internal space of the curved frame 110 of the constipation apparatus 100 and supplies air created through a supply pipe 1 to an air cell.

Each solenoid valve 170 configuring the solenoid valve group 170a to 170e is installed at a supply pipe 1 in the internal space of the curved frame 110 of the constipation apparatus 100 and may control a flow of air.

Here, the heat/module group may include a lower right heat/message module 151a, a right heat/message module 151b, a central heat/message module 151c, a lower left heat/message module 151d, and a left heat/message module 151e.

Further, each heat/message module 150a to 150e may include an upper air cell 150-1, a lower air cell 150-2, and a heat generation module 150-3.

The solenoid valve group may include a lower solenoid valve 170a, a right solenoid valve 170b, a central solenoid valve 170c, a lower left solenoid valve 170d, and a left solenoid valve 170e.

Moreover, each solenoid valve 170a to 170e may include a solenoid valve 170.

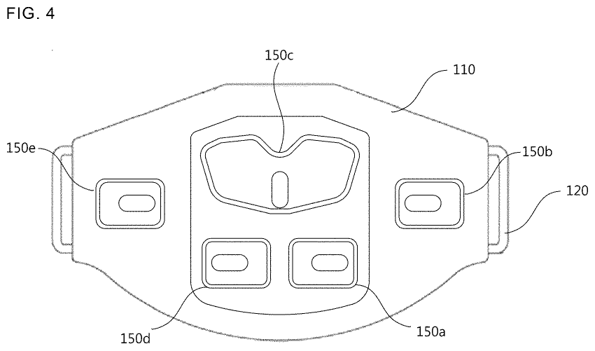

That is, as shown in FIG. 4, the constipation apparatus 100 using warm and air cells may include heat/message modules 150a to 150e divided into five parts and may include a heat generation module 150-3 and air cells 150-1 and 150-2 every each divided part.

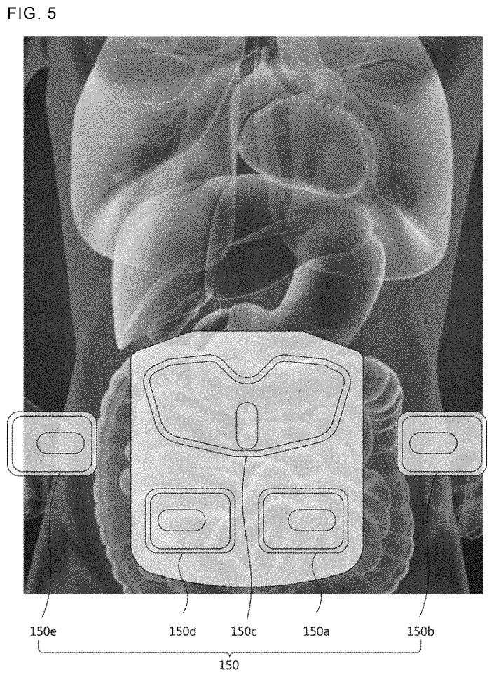

The reason to configure the above that a phenomenon such as stiffness may occur due to skeleton when the above is matched with bowel movement as shown in FIG. 5 and it is wrongly arranged by taking into consideration a skeleton structure of a person.

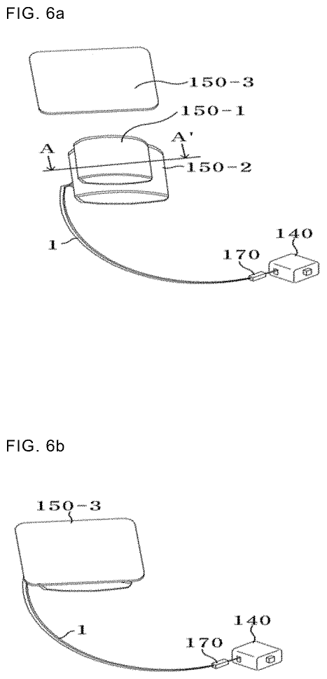

As shown in FIG. 6, in the heat generation module 150-3 and the air cells 150-1 and 150-2, since the air cells 150-1 and 150-2 are overlapped with each other as an upper portion of the heat generation module 150-3 making contact with a body, the heat generation module 150-3 is arranged to make contact with an inner side, that is, a body skin.

The heat generation module 150-3 is arranged to make contact with an inner side, that is, a body skin so that bowel may be further pressed by expansion pressure upon expansion of the air cells 150-1 and 150-2 under control of a control unit 180 for the air cells 150-1 and 150-2.

As shown in FIG. 6, the air cells 150-1 and 150-2 have a dual structure and include an upper air cell 150-1 and a lower the air cell 150-2. The reason to form the dual structure is that the dual structure may easily compress and expand the air cells and may deeply a body skin.

That is, if the size (area) of the air cell is increased, a billowed degree is increased so that a billowed height is increased. However, it is difficult to be divided and used the air cell so that the air cell cannot message according to bowel movement. When the air cells are divided and used in a small size, a pressed height is reduced so that there is no message effect. Accordingly, the air cells are divided in the upper air cell 150-1 and the lower air cell 150-2 in a small size and have a dual structure in order to represent message effects.

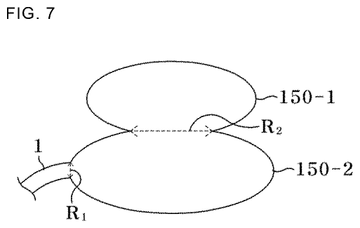

In this case, as shown in FIG. 6 and FIG. 7, if a diameter R1 of an air supply port of the lower air cell 15-2 is greater than a diameter R2 of an air supply port of the upper air cell 15-1, an internal volume of the lower air cell 15-2 is greater than an internal volume of the upper air cell 15-1. Accordingly, compression and expansion are easy while matching air pressure with balance. Further, air is sequentially supplied into the upper air cell 15-1 through the lower air cell 15-2 to efficiently stimulate a stomach located in a deep position of a body.

Meanwhile, the upper air cell 150-1 and the lower air cell 150-2 include thermo plastic polyurethane (TPU), and may have easy compression and expansion, and may have durability capable of withstanding pressure.

In the meantime, a reason why the present invention uses the air cells 150-1 and 150-2 is because it is difficult to adjust intensity of a cam of an existing message device if the cam messages bowel and additional pressure is not generated if the cam makes contact with a bone part. Accordingly, the present invention applies a method of using air pressure.

As shown in FIG. 4 and FIG. 5, divided parts (five pieces) of the air cells 150-1 and 150-2 and the heat generation module 150-3 include one upper piece corresponding to the central heat/message module 150c, lower two pieces corresponding to the lower right heat/message module 150a and a lower left heat/message module 150d, a left piece corresponding to a left heat/message module 150, and a right piece corresponding to a right heat/message module 150d.

For this reason, an upper region of the central heat/message module 150c is connected to bowel so that one piece may message. The reason why the above is configured according to bowel movement because a lower area corresponding to the lower right heat/message module 150a, the right heat/message module 150b, the lower left heat/message module 150d, and the left heat/message module 150e is not connected to the bowel. Furthermore, it is preferred that the right heat/message module 150b and the left heat/message module 150e corresponding to right and left pieces are positioned suited to a body skeleton.

In addition, a valve for injecting air into respective air cells 150-1 and 150-2 of the heat/message module group 150a to 150e may use a solenoid valve 170 so that the control unit 180 may control each solenoid valve 170 and the vacuum motor 140 to inject air into the lower air cell 150-2 from the vacuum motor 140.

An operation method of the air cells 150-1 and 150-2 formed at the lower right heat/message module 150a, the right harm heat/message module 150b, the central harm heat/message module 150c, the lower left heat/message module 150d, and the left heat/message module 150e configuring the heat/message module group 150a to 150e by the control unit 180 will be described as follows.

The control unit 180 injects air into the upper and lower air cells 150-1, 150-2 by injecting air into the lower air cell 150-2 according to valve ON control with respect to the lower right solenoid valve 170a to inject air provided to the upper and lower air cells 150-1 and 150-2 included in the lower right harm heat/message module 150a and the right heat/message module 150b from the vacuum motor 140.

Next, the control unit 180 removes air inside the upper and lower air cells 150-1 and 150-2 of the lower right heat/message module 150a according to valve OFF control with respect to the lower right solenoid valve 170a, and injects air into the upper and lower air cells of the central heat/message module 150c corresponding to an upper air cell while maintaining air pressure in the upper and lower air cells 150-1 and 150-2 included in the right heat/message module 150b so that the air is injected at a right side and an upper portion of the bowel.

Next, the control unit 180 removes air according to valve OFF control with respect to the right solenoid valve 170b to remove air with respect to the upper and lower air cells 150-1 and 150-2 included in the right heat/message module 150b corresponding to a right air cell, controls the solenoid valve 170 configuring the left solenoid valve 170e by valve ON to inject air into the upper and lower air cells 150-1 and 150-2 included in the left heat/message module 150e corresponding to a left air cell, so that air pressure is maintained at an upper portion and a left side of the bowel.

Finally, the control unit 180 valve OFF controls the solenoid valve 170 corresponding to the central solenoid valve 170c to remove air injected in the upper and lower air cells 150-1 and 150-2 included in the central heat/message module 150c corresponding to an upper cell, and valve ON controls the solenoid valve 170 corresponding to the lower left solenoid valve 170d to inject air into the upper and lower air cells 150-1 and 150-2 included in the lower left heat/message module 150d corresponding to a lower left air cell while maintaining the air in the upper and lower air cells 150-1 and 150-2 of the left heat/message module 150e corresponding to a left air cell, so that air is injected.

Accordingly, air pressure is injected such as stomach movement clockwise to maintain air in two adjacent air cells similar to the movement direction of stomach. Otherwise, food inside the stomach (stomach twist) may back-flow.

Further, in an embodiment of the present invention, the heat generation module 150-3 formed at each heat is PCB heating element, when air is injected inside the upper and lower air cells 150-1 and 150-2 included in respective heat/message module 150a to 150e under control of the control unit 180, the heat generation module 150-3 generates heat under the control of the control unit 180. Since the air is injected inside the upper and lower air cells 150-1 and 150-2 included in respective heat/message module 150a to 150e by a vacuum motor 140 as described above, the air generated by the vacuum motor 140 is repeatedly injected and exhausted inside the upper and lower air cells 150-1 and 150-2 included in the respective heat/message module 150a to 150e so that the bowel may be activated and the constipation may be cured.

In the present invention, it is preferred that the control unit 180 provides a function of a safety device to force stop once after 15 minutes, and further includes a temperature sensing function so that a heat generation temperature of the heat generation module 150-3 does not exceed a maximum 80° C.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A constipation treatment apparatus using warm and air cells, the apparatus comprising:
a vacuum motor installed at an internal space of a curved frame to supply air generated from a supply pipe 10 to the air cell;
a heat/message module group including a lower right heat/message module, a right heat/message module, a central heat/message module, a lower left warm/message module, and a left heat/message module, each of the heat/message modules including an air cell and a heat generation module; and
a control unit configured to control the heat generation module and the air cell every divided part where the heat/message modules are divided into a plurality of parts,
wherein the air cell is configured by a dual structure including an upper air cell and a lower air cell,
a diameter of an air supply port of the lower air cell is greater than a diameter of an air supply port of the upper air cell,
the supply pipe is connected to the lower air cell, the air supplied from the vacuum motor is supplied to an air supply port of the upper air cell through the supply pipe and an air supply port of the upper air cell so that the air is sequentially injected into the upper air cell.

2. The constipation treatment apparatus using warm and air cells of claim 1, further comprising a solenoid valve group configured by a solenoid valve installed at the supply pipe at an internal space of the curved frame of the constipation treatment apparatus using warm and air cells.

3. The constipation treatment apparatus using warm and air cells of claim 2, wherein the solenoid valve group performs air injection and exhaustion with respect to the air cell of at least one heat/message module of the heat/message module group.

4. The constipation treatment apparatus using warm and air cells of claim 1, wherein the air cells are overlapped with an upper portion of the heat generation module making contact with a body.

5. The constipation treatment apparatus using warm and air cells of claim 1, wherein the heat generation module internally makes contact with a body skin.
